(19) United States
(12) Patent Application Publication
(10) Pub. No.: US 2019/0219147 A1
(43) Pub. Date: Jul. 18, 2019

(54) GEAR FOR A TORQUE TRANSMISSION DEVICE AND METHOD FOR MAKING THE GEAR

(71) Applicant: ILJIN USA Corporation, Novi, MI (US)

(72) Inventors: Daniel TILTON, Novi, MI (US); Gary SCHULTE, Novi, MI (US); Ailton SILVA, Novi, MI (US); Michael LEWIS, Novi, MI (US)

(21) Appl. No.: 15/873,424

(22) Filed: Jan. 17, 2018

(51) Int. Cl. F16H 55/06; B22F 5/08; B23P 15/14; B23K 11/11; F16H 55/17; B21K 1/30

(52) U.S. Cl. CPC F16H 55/06; B22F 5/08; B23P 15/14; B23K 2201/008; F16H 55/17; B21K 1/30; B23K 11/115

(57) ABSTRACT

A gear for a torque transmission device includes a gear member and a support member with a weld formed therebetween, and the gear member has a first surface and a second surface. The first surface has teeth. The support member has a support surface. The weld attaches the second surface of the gear member and the support surface. Portions of the second surface of the gear member and the support surface which contact the weld are ungrooved.

### CROSS REFERENCES TO RELATED APPLICATIONS

Not Applicable

### STATEMENT REGARDING FEDERALLY SPONSORED RESEARCH

Not Applicable

### BACKGROUND

### A. Technical Field

The present disclosure relates to a gear for a torque transmission device and a method for fabricating the gear.

### B. Discussion of the Prior Art

Gears are ubiquitous elements in devices requiring transmission of torsional loads. In the case of high-load applications, gears must be made of materials with sufficient strength and mechanical properties to withstand high loads at the point of contact.

Gears for modern torque or power transmission devices are typically made entirely out of a single material such as wrought steel or powdered metal. A gear made of wrought steel may carry high loads, but will require more complicated production methods. Conversely, a gear made of powdered metal requires relatively less complicated production methods. However, powdered metal is not strong enough to handle high torque applications without additional, costly, heat treatment. Thus, making either the wrought steel gear or the powdered metal gear involves high manufacturing cost and complexity.

### SUMMARY

The present subject matter is directed to gears and methods for making gears comprising mechanically dissimilar materials. Specifically, the present subject matter is directed to a gear comprising a support member, a gear member, and a weld therebetween. The gear member of the gear in some embodiments has a first surface with teeth and a second surface. The support member has a support surface. The weld attaches the second surface of the gear member with the support surface. In this manner, the gear member and support member indirectly contact each other in a contact region through a weld disposed between them. Finally, portions of the second surface of the gear member and the support surface which contact each other in the contact region through the weld are ungrooved.

For example, the present gear may be made by combining a steel plate with powdered metal gear teeth attached through a weld. at the contact region. This can be done using a special welding process to combine the wrought steel plate and powdered metal gear teeth. Such a gear provides easy, cost effective manufacturing while maintaining the necessary support strength for a gear used in high torque applications.

The subject matter of the present disclosure is also related to methods of fabricating the gear described above. In particular, the present subject matter relates to methods in which the gear member and support member that best suits a particular application of the gear, and a weld is formed at the contact region between the support member and the gear member using a capacitor discharge welding process such that the side of the gear member having the teeth is opposite the side contacting the weld.

In some embodiments, the capacitor-discharge welding process may specifically include placing the gear member on the support member to form an initial contact surface; placing an electrode on one side of the gear member away from the initial contact surface; placing another electrode on the support member away from the initial contact surface; and forming the weld at the contact surface, which becomes the contact region, by capacitor discharge welding.

Other embodiments of the present subject matter may include a gear for a torque transmission device having a support member, a gear member and a weld therebetween, wherein the support member has a face with one or more grooves configured to accept an axial load; the weld is formed on an ungrooved portion of the face with the one or more grooves; the gear member has teeth on a side opposite to a side contacting the weld; and the weld exists at a contact region between the support member and the gear member and the contact is ungrooved.

The gears and methods of making said gears described here may be adapted to best suit the intended application. Such gears provide advantages over prior technology of the relative ease and inexpensiveness of forming detailed features, such as gear teeth, out of powdered metal and the strength of wrought steel at a point of high-torque application.

In this regard, in certain high-load applications, the point of high torque transmission may not be through the teeth of the gear. For example, a high load may be applied axially to a support plate of the gear, and relatively moderate to low torque would in turn be applied through the teeth of the gear. For such high axial load applications, the gear teeth do not have the same strength and material requirements as the support plate of such a gear, due to the moderate-to-low torque imposed on the gear teeth. The present gears improve upon typical gears used in such applications by combining the cost-effectiveness and easy production of softer gear teeth—for example, powdered metal without requisite extra heat treatments—with the strength of a metal support plate.

The foregoing and other features and advantages of the present subject matter are more readily apparent from the following detailed description. The detailed description proceeds with references to the accompanying drawings.

### BRIEF DESCRIPTION OF THE DRAWINGS

The accompanying drawings, which are included to provide a further understanding of the subject matter and are incorporated in and constitute a part of this specification, illustrate non-limiting embodiments of the subject matter and, together with the description, serve to explain the principles of the subject matter: In the drawings:

FIG. 1 is a perspective view of a gear according to a first embodiment.

FIG. 2 is an exploded view of the gear disclosed in FIG. 1.

FIG. 3 is a plan view of the gear disclosed in FIG. 1.

FIG. 4 is a cross sectional view taken along line IV-IV in FIG. 3.

FIG. 5 is a perspective view of a gear according to a second embodiment.

FIG. 6 is an exploded view of the gear disclosed in FIG. 5.

FIG. 7 is a plan view of the gear disclosed in FIG. 5.

FIG. 8 is a cross sectional view taken along line VIII-VIII in FIG. 7.

FIG. 9 is a perspective view of a gear according to a third embodiment.

FIG. 10 is an exploded view of the gear disclosed in FIG. 9.

FIG. 11 is a plan view of the gear disclosed in FIG. 9.

FIG. 12 is a cross sectional view taken along line XII-XII in FIG. 11.

FIG. 13 is a perspective view of a gear according to a fourth embodiment.

FIG. 14 is an exploded view of the gear disclosed in FIG. 13.

FIG. 15 is a plan view of the gear disclosed in FIG. 13.

FIG. 16 is a cross sectional view taken along line XVI-XVI in FIG. 15

FIG. 17 is a perspective view of a gear according to a fifth embodiment.

FIG. 18 is an exploded view of the gear disclosed in FIG. 17.

FIG. 19 is a plan view of the gear disclosed in FIG. 17.

FIG. 20 is a cross sectional view taken along line XX-XX in FIG. 19.

FIG. 21 is a flowchart showing a method for fabricating a gear according to any one of the first to sixth embodiments.

### DETAILED DESCRIPTION

In the following detailed description, reference is made to the accompanying drawings, which form a part hereof, and in which are shown by way of illustration specific embodiments in which the subject matter may be practiced. In this regard, terminology such as “first,” “then,” “afterwards,” “before,” “next,” “finally,” “above,” “below,” “top,” “bottom,” “front,” “back,” “leading,” “trailing,” etc., is used with reference to the drawing being described. Because the individual elements of the apparatus of the present subject matter may be configured in a number of different orders and geometries, and the methods of the present subject matter can be performed in a number of different orders, the above terminology is used for purposes of illustration and is in no way limiting. It is to be understood that other embodiments may be utilized, and logical changes may be made without departing from the scope of the present subject matter. The following detailed description, therefore, is not to be taken in a limiting sense, and the scope of the present subject matter includes the full scope of the appended claims.

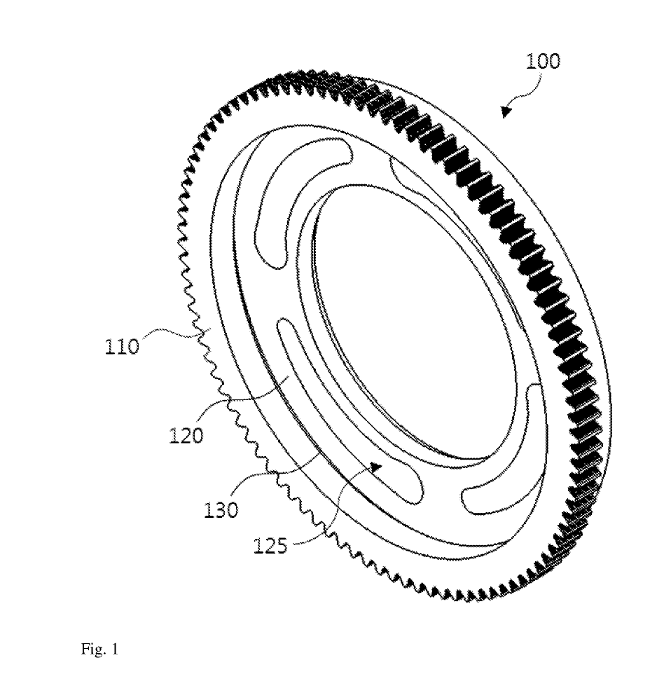

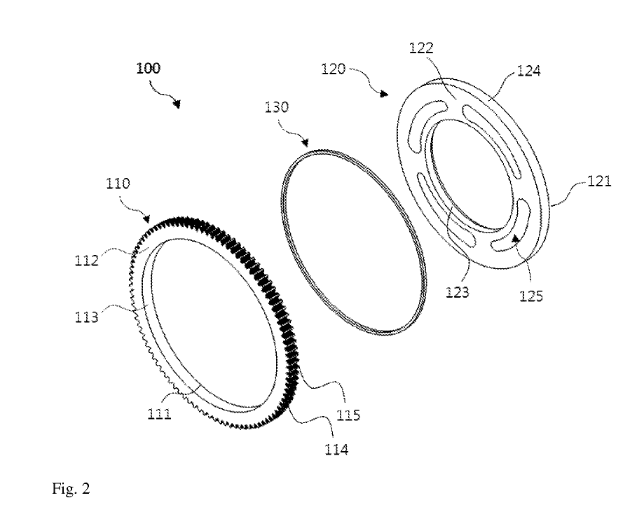

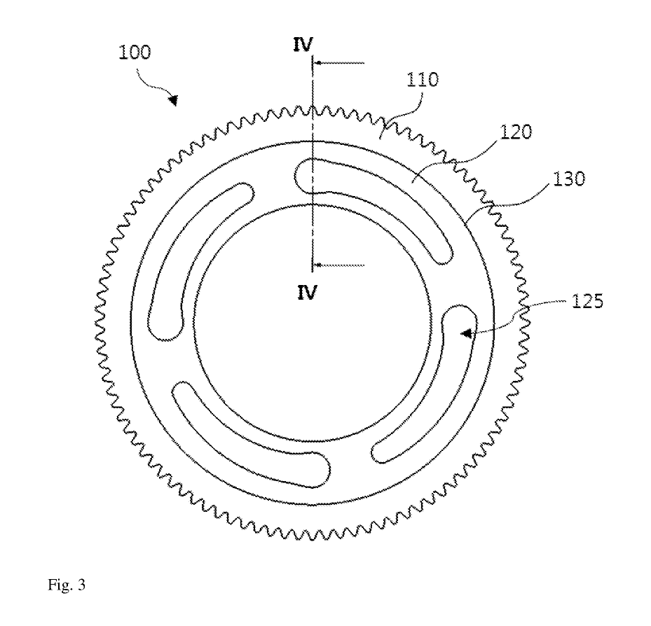

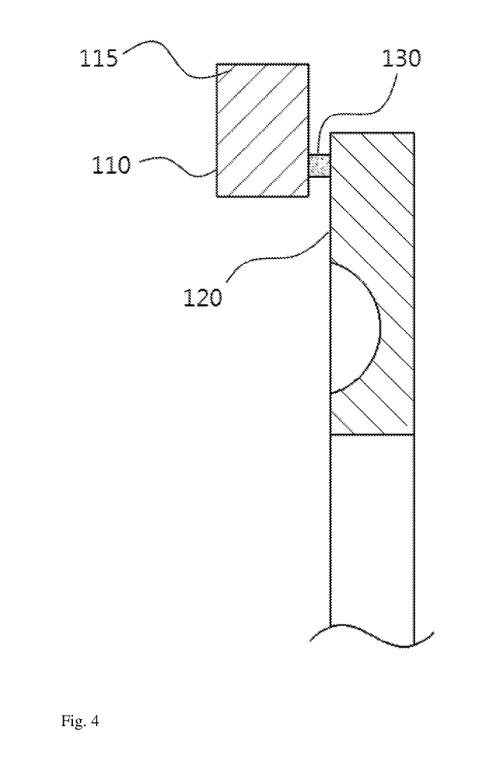

FIGS. 1-4 disclose a gear 100 according to a first embodiment. As shown in FIGS. 1-4, a gear member 100 according to the first embodiment includes a gear member 110, a support member 120, and a weld 130 formed between them. The support member 120 is toroidal, but is not so limited. As shown in FIG. 2, the support member 120 has a bottom surface 121 and a top surface 122, as well as an inside surface 123 and a circumferential surface 124 connecting the bottom surface 121 and the top surface 122. The gear member 110 includes a toroidal body having a bottom surface 111, a top surface 112, and inside surface 113 and a circumferential surface 114 connecting the bottom surface 111 and the top surface 112, and teeth 115 formed on the circumferential surface 114. Although the support member 120 is shown as toroidal in FIGS. 1-4, the shape of the support member 120 is not particularly limited, and may be chosen so as to best suit the intended use of the gear. For example, the support member 120 may be cylindrical, lacking an inside surface.

The gear member 110 may include teeth 115 on the circumferential surface 114. Although the teeth 115 is shown in FIG. 2 as being formed along the entire circumferential surface 114, the teeth 115 may be formed along a portion of the circumferential surface 114. The weld 130 is formed on the top surface 122 of the support member 120 along the circumferential surface 124 of the support member 120. The weld 130 is formed in the contact region along the entirety of the top surface 122 of the support member 120. At the same time, the weld 130 is formed along the bottom surface 111 of the gear member 110.

The gear member 110 is driven and rotated by a mating gear (not shown). The support member 120 which is integrally coupled with the gear member 110 through the weld 130 is rotated with the gear member 110. The support member 120 may include a means for converting the rotary motion of the support member 120 to a linear motion. For example, as shown in FIGS. 1-4, one or more grooves 125 is formed on the top surface 122 of the support member 120. Each of the grooves 125 may be a ramp groove, with the depth of the ramp groove being gradually changed in the circumferential direction. A ball is retained in each of the one or more groove 125. When the support member 120 is rotated, the ball is moved along the ramp groove 125. As a result, the ball moves linearly in an axial direction of the support member 120.

Due to these different structures and functions of the gear member 110 and the support member 120, the load to which the teeth 115 of the gear member 110 are subject is smaller than the load to which the grooves 125 are subject. That is, the minimum strength necessary for the teeth 115 of the gear member 110 is smaller than the minimum strength for the grooves 125 of the support member 120.

According to the first embodiment, since the gear member 110 and the support member 120 are different parts and the needed strengths are different, the gear member 110 and the support member 120 may be manufactured with different materials and/or manufacturing methods to reduce the manufacturing costs.

For example, the support member 120 which should have high strength may be made from wrought steel, and the gear member 110 may be made from powdered metal, since the teeth 115 may be easily formed and the teeth 115 do not need to be strong compared to the support member 120. However, the materials of the gear member 110 and the support member 120 are not particularly limited to powdered metal and wrought steel, and may be chosen in any way such that the gear member 110 and the support member 120 meet their minimum strengths. The gear member 110 is preferably a sinter-hardening metal, and may otherwise be chosen from any commercially available or novel material to suit the needs of the application. The material comprising the support member 120 is similarly not particularly limited, but may be, for example, forged or cast steel or another metal. For certain high-load applications, the material comprising the support member 120 may advantageously have a minimum hardness of 57 HRC, and/or a stress capacity of 3,000 MPa. Additional properties of the support member 120 for certain high-load applications which are possible, but not generally required, include a high superficial Carbon layer of 1.1 mm minimum and a low Carbon core for impact resistance.

In order to combine the gear member 110 and the support member 120, the weld 130 is formed in the contact region along the bottom surface 111 of the gear member 110 and the top surface 122 of the support member 120. The bottom surface 111 of the gear member 110 and a portion of the top surface 122 of the support member 120 are ungrooved. This allows the weld 130 to be formed quickly and uniformly between the bottom surface 111 of the gear member 110 and the ungrooved portion of the top surface 122 of the support member 120 along the entire circumferential surface 124 of the support member 120. Thus, distortion due to excessive heat or movement during welding may be minimized. This advantage is maximized when the weld 130 is formed using a capacitor-discharge process. The capacitor-discharge process used in forming the weld 130 is a quick process, allowing for the weld to be formed in milliseconds.

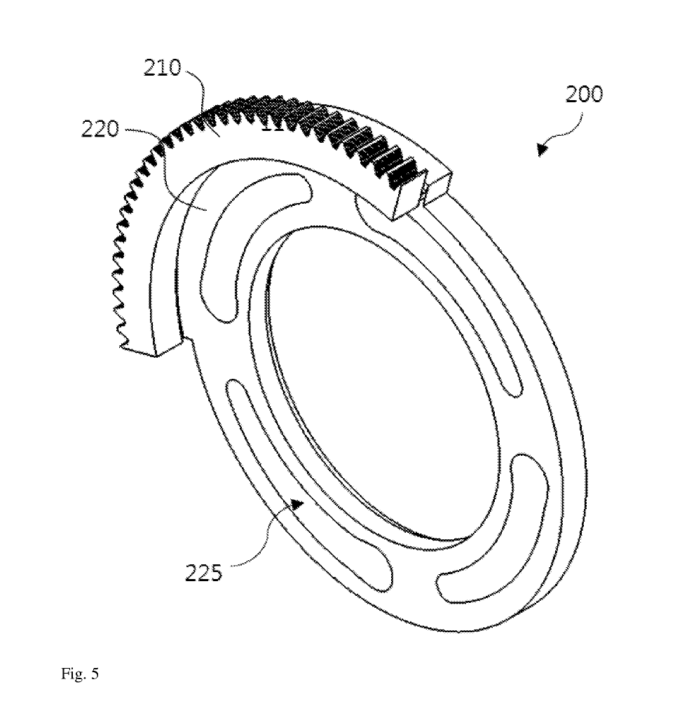

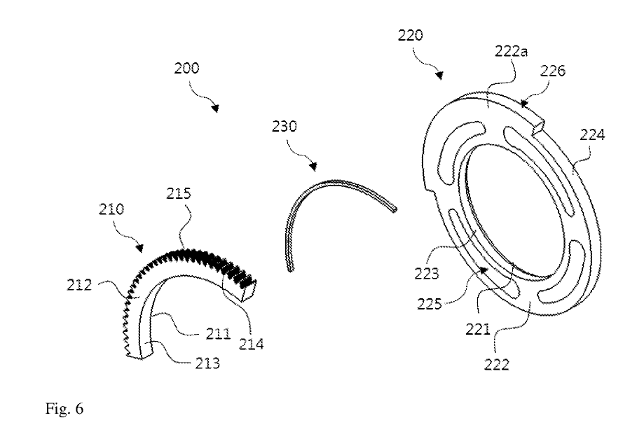

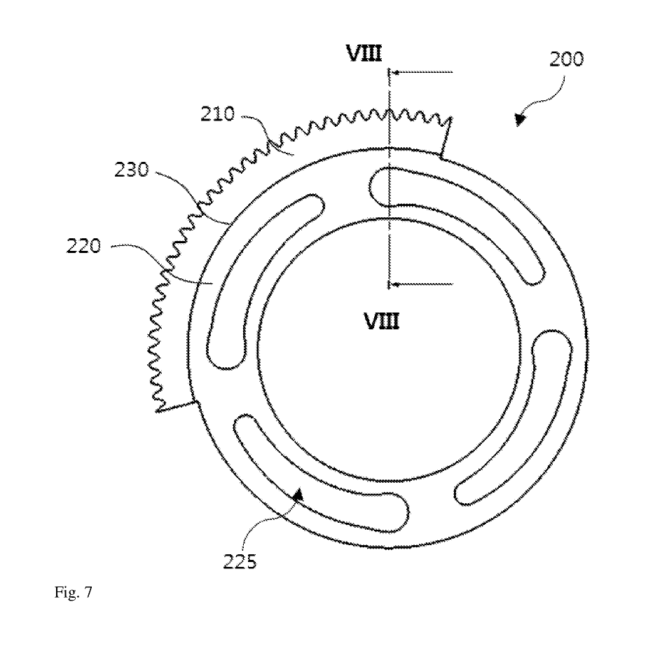

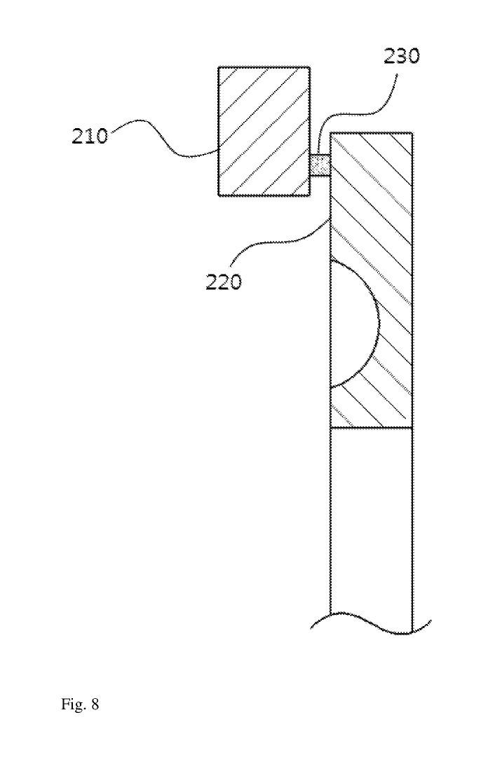

FIGS. 5-8 disclose a gear 200 according to a second embodiment. As shown in FIGS. 5-8, in the gear 200 according to the second embodiment a weld 230 is formed along a portion of the top surface 222 of a support member 220 and a gear member 210 is provided at the weld 230 only. Similar to the first embodiment, the support member 220 of the second embodiment has a bottom surface 221 and a top surface 222, as well as an inside surface 223 and a circumferential surface 224 connecting the bottom surface 221 and the top surface 222. One or more grooves 225 is formed on the top surface 222 of the support member 220. The gear member 210 includes a bottom surface 211, a top surface 212, an inside surface 213 and a circumferential surface 214 connecting the bottom surface 211 and the top surface 212, and teeth 215 formed on the circumferential surface 214.

The top surface 222 of the support member 220 includes a region which is ungrooved and is welded to the bottom surface 211 of the gear member 210.

For example, the support member 220 may include a protrusion 226 on the circumferential surface 224. In such a case, a region 222a of the top surface 222 corresponds to the protrusion 226. That is, the weld 230 is formed along the region 222a of the top surface 222 of the support member 220 at the protrusion 226. At the same time, the weld 230 is formed along the bottom surface 211 of the gear member 210. One or more grooves 225 is formed on the top surface 222 of the support member 220 outside the welding region 222a of the top surface 222 of the support member 220.

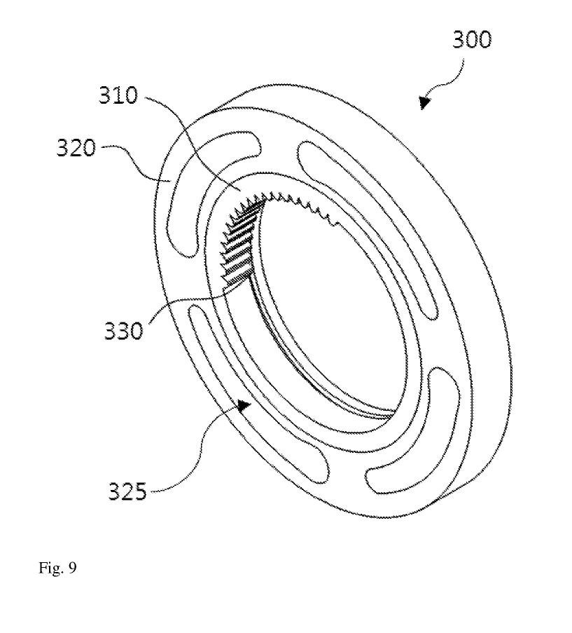

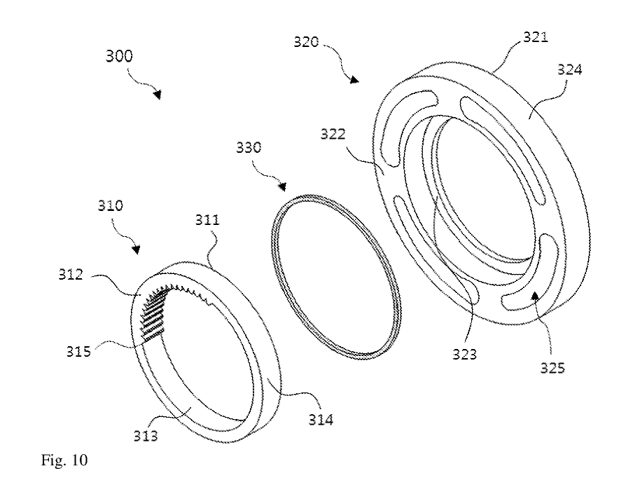

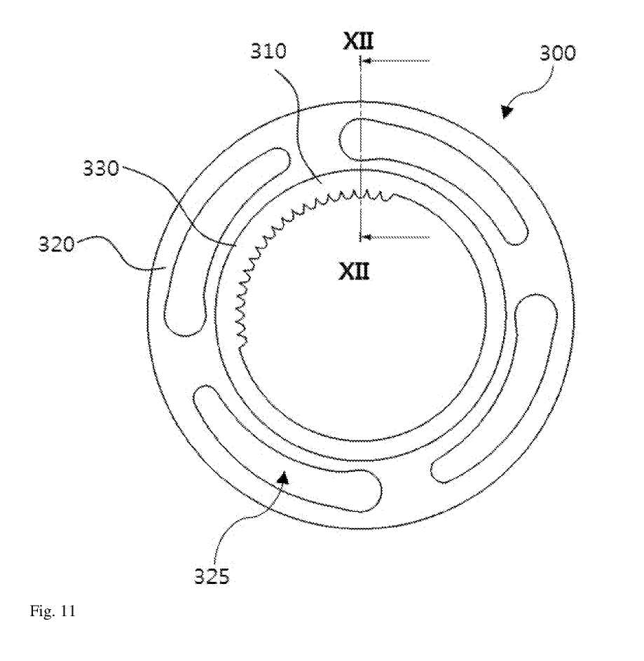

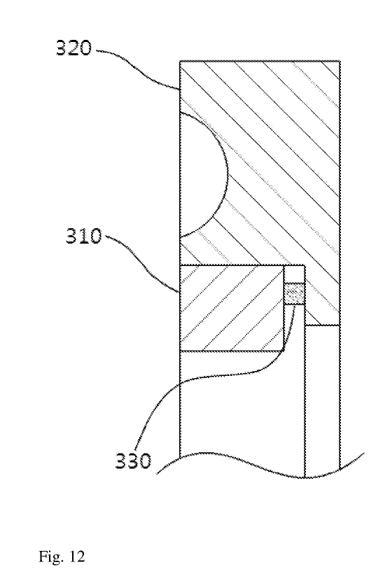

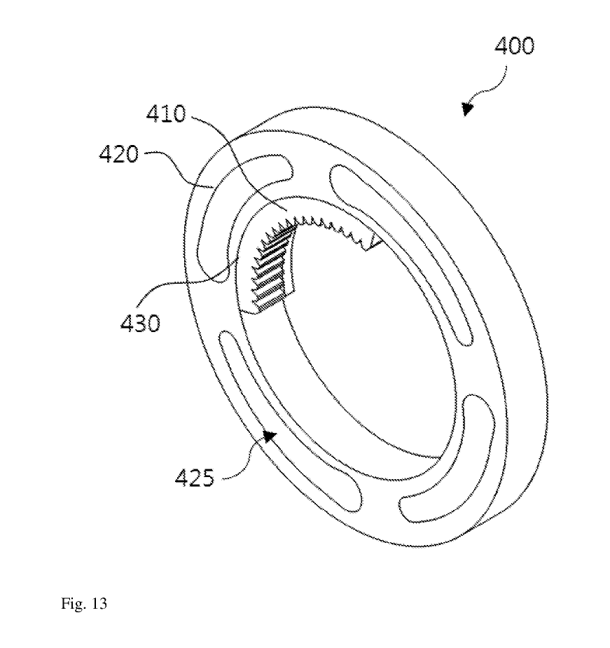

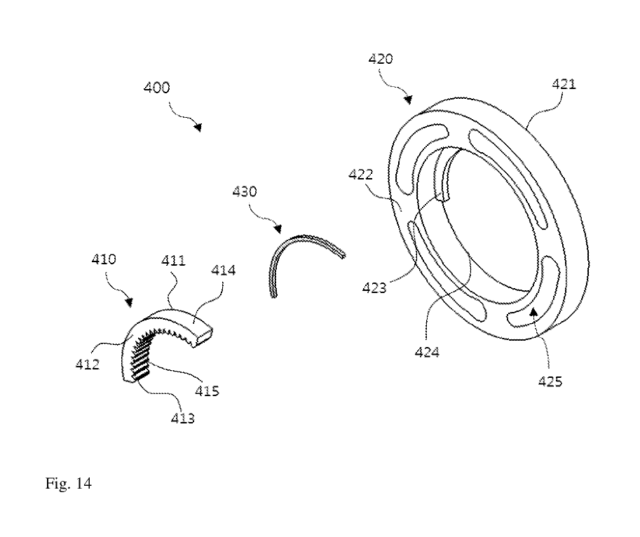

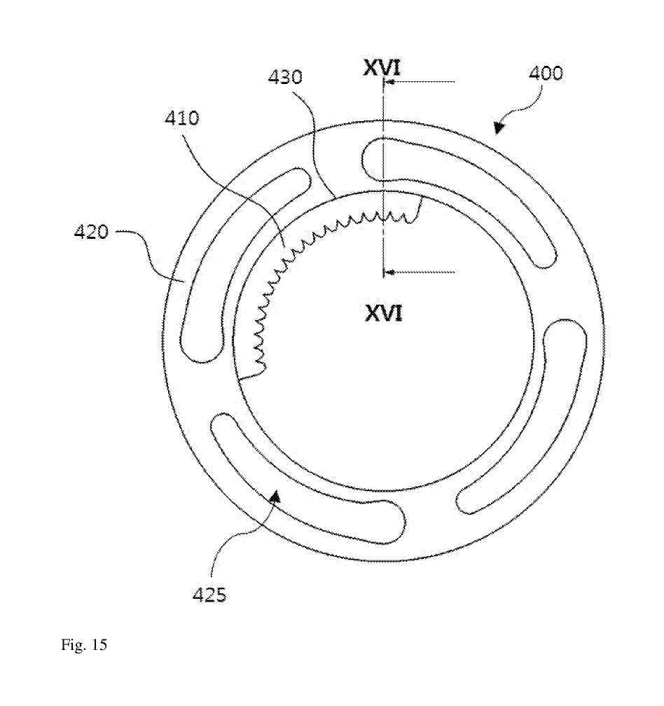

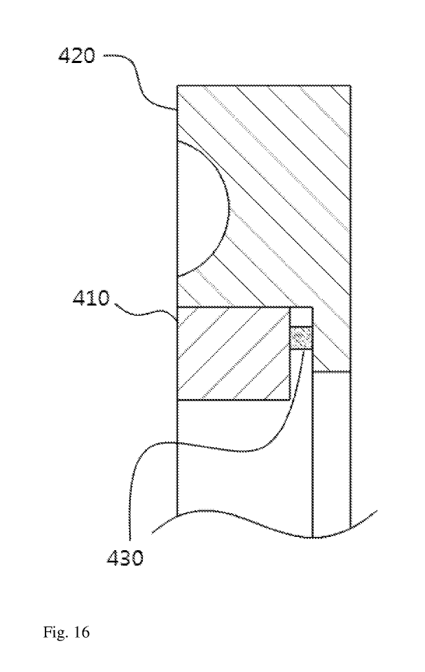

FIGS. 9-12 disclose a gear 300 according to a third embodiment. Further, FIGS. 13-16 disclose a gear 400 according to a fourth embodiment. The support members 320, 420 are toroidal.

Each support member 320, 420 has a bottom surface 321, 421 and a top surface 322, 422, as well as an inside bottom surface 323, 423 and a circumferential surface 324, 424 connecting the bottom surface 321, 421 and the top surface 322, 422. One or more grooves 325, 425 are formed on the top surface 322, 422 of the support 320, 420. Each gear member 310, 410 includes a bottom surface 311, 411, a top surface 312, 412, an inside surface 313, 413 and a circumferential surface 314, 414 connecting the bottom surface 311, 411 and the top surface 312, 412, and teeth 315, 415 formed on the inside surface 313, 413.

As shown in FIGS. 9-16, the weld 330, 430 is formed along the inside bottom surface 323, 423 of the gear member 310, 410 in the contact region. As shown in FIGS. 9-12, the weld 330 of the third embodiment is formed along the entirety of the inside bottom surface 323 of the support member 320. Alternatively, as shown in FIGS. 13-16, the weld 430 of the fourth embodiment is formed along a portion of the inside bottom surface 423 of the support member 420 and the gear member 410 is provided at the weld 430 formed along this portion of the top surface 422 along the corresponding portion of the inside bottom surface 423 only. One or more grooves 325, 425 is formed on the top surface 322, 422 of the support member 320, 420.

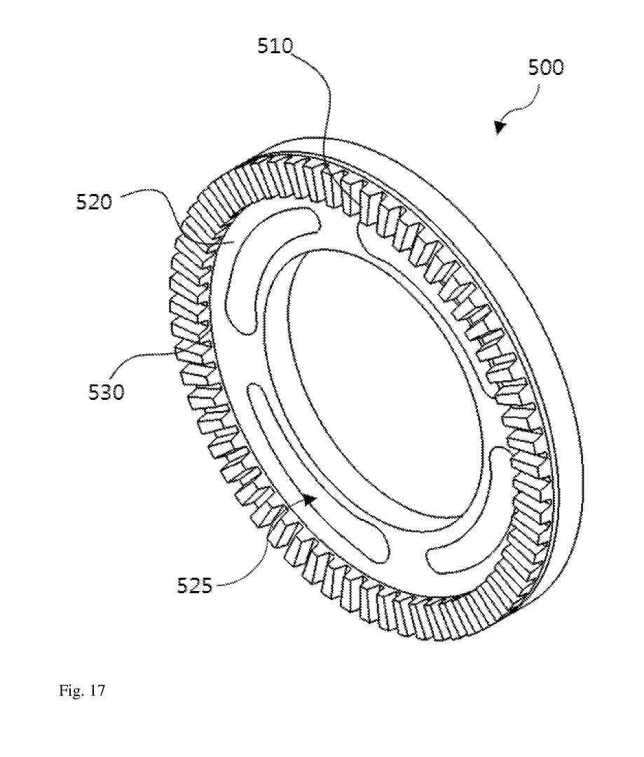

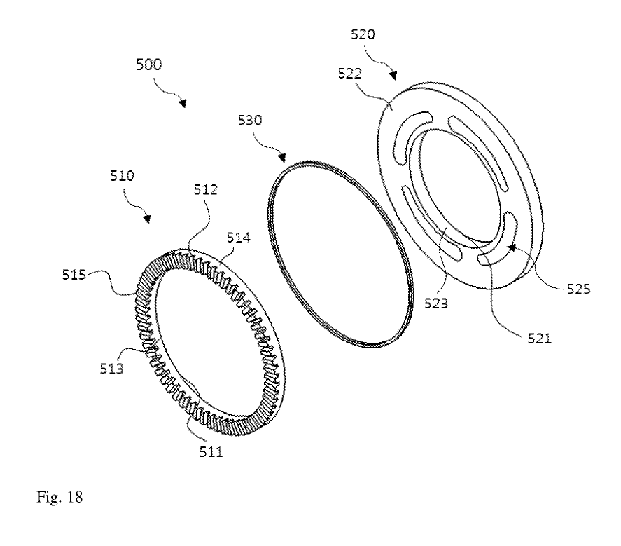

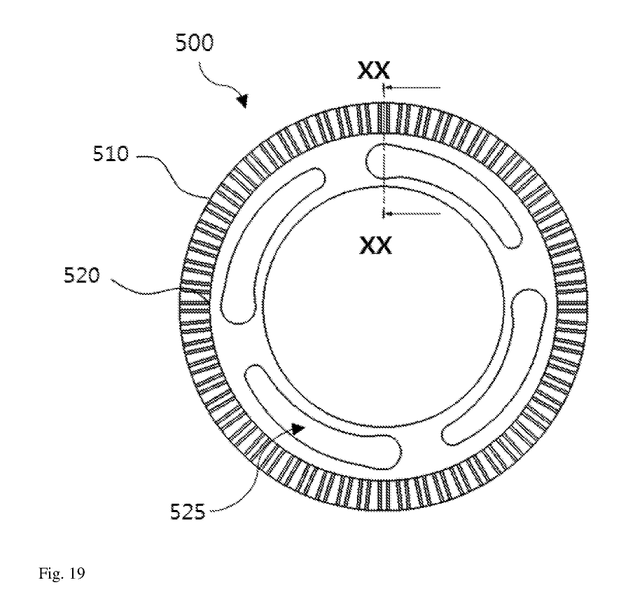

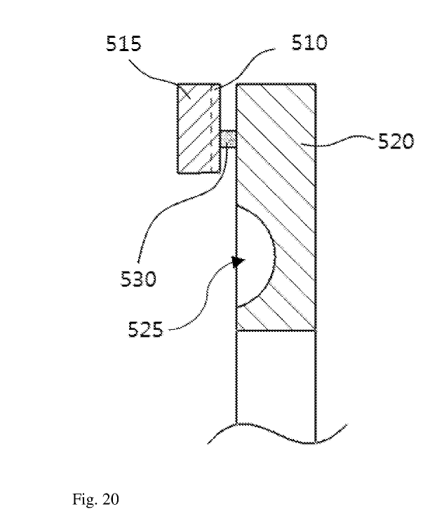

FIGS. 17-20 disclose a gear 500 according to a fifth embodiment. The support member 520 may be cylindrical or toroidal. If the support member 520 is toroidal, the support member 520 includes a top surface 522, a bottom surface 521, an inside surface 523 and a circumferential surface 524 connecting the bottom surface 521 and the top surface 522. The gear member 510 includes a toroidal body having a bottom surface 511, a top surface 512, an inside surface 513 and a circumferential surface 514 connecting the bottom surface 511 and the top surface 512, and teeth 515 formed on the top surface 512. The gear member 510 is coupled to the top surface 522 of the support member 520 via a contact region through a weld 530. One or more grooves 525 are formed on the top surface 522 of the support member 520 outside the contact region.

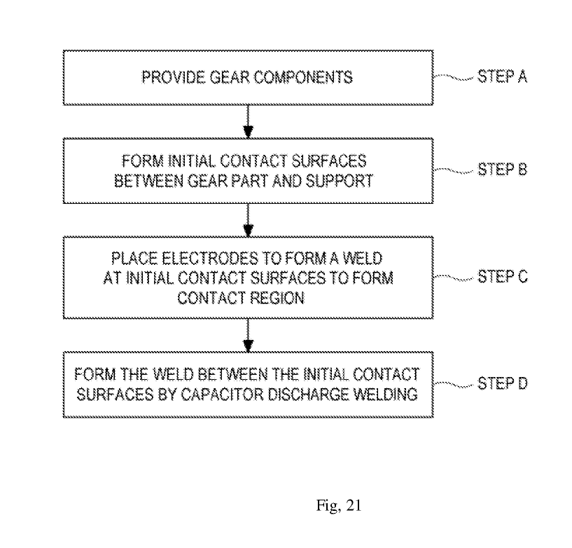

FIG. 21 is a flowchart showing a method for fabricating a gear according to any one of the first to fifth embodiments.

The weld 130, 230, 330, 430, 530 may advantageously be formed using a capacitor-discharge process. In particular, the gear member 110, 210, 310, 410, 510 and the support member 120, 220, 320, 420, 520 may be provided with features to best suit the intended application as described above (Step A), and arranged to form an initial contact surface by placing the gear member 110, 210, 310, 410, 510 on the support member 120, 220, 320, 420, 520 where required (Step B). An electrode may be placed on one side of the gear member 110, 210, 310, 410, 510 away from the initial contact surface and another electrode may be placed on the support member 120, 220, 320, 420, 520 away from the initial contact surface (Step C), and then the weld 130, 230, 330, 430, 530 may be formed at the contact region by capacitor discharge welding (Step D). This method of welding has the advantage of being very fast, preferably forming the weld on an order of magnitude of milliseconds, and minimizing distortion due to excessive heat or movement during welding.

The gears and methods of making said gears described here may be adapted to best suit the intended application. Such gears provide the advantages over prior technology of the relative ease and inexpensiveness of forming detailed features, such as gear teeth, out of softer materials or more easily manipulated materials—for example, powdered metals—and the strength of harder materials—for example, wrought or cast metals—at the point of high-torque application.

With the information contained herein, various departures from precise descriptions of the present subject matter will be readily apparent to those skilled in the art to which the present subject matter pertains, without departing from the spirit and the scope of the below claims. The present subject matter is not considered limited in scope to the procedures, properties, or components defined, since the preferred embodiments and other descriptions are intended only to be illustrative of particular aspects of the presently provided subject matter. Indeed, various modifications of the described modes for carrying out the present subject matter which are obvious to those skilled in torque transmission devices, material properties of and manufacturing using powdered and wrought metals, welding techniques, or related fields, are intended to be within the scope of the following claims.

What is claimed is:

1. A gear for a torque transmission device comprising:
gear member having a first surface and a second surface, the first surface having teeth;
a support member having a support surface; and
a weld formed in a contact region along the second surface of the gear member and the support surface,
wherein portions of the second surface of the gear member and the support surface to which the weld is attached are ungrooved.

2. The gear for a torque transmission device according to claim 1, wherein the second surface is located opposite of the first surface.

3. The gear for a torque transmission device according to claim 1, wherein the gear member is toroidal and the first surface is a top surface and the second surface is an inside surface.

4. The gear for a torque transmission device according to claim 1, wherein the hardness of the gear member is less than that of the support member.

5. The gear for a torque transmission device according to claim 1, wherein the support member further includes a third surface with one or more grooves configured to accept an axial load.

6. The gear for a torque transmission device according to claim 1, wherein the support member is cylindrical or toroidal.

7. The gear for a torque transmission device according to claim 6, wherein the support surface is a top surface of the support member, with the weld formed thereon.

8. The gear for a torque transmission device according to claim 7, wherein the weld is formed in the contact region along the entirety of the top surface of the support member, and the gear member is provided at the weld only.

9. The gear for a torque transmission device according to claim 6, wherein the weld is formed in the contact region along a portion of the support surface of the support member and the gear member is provided at the weld only.

10. The gear for a torque transmission device according to claim 6, wherein the support member is toroidal and the weld is on the support surface, which is a top surface of the support member.

11. The gear for a torque transmission device according to claim 10, wherein the weld is formed in the contact region along the entirety of the top surface of the support member and the gear member is provided at the weld only.

12. The gear for a torque transmission device according to claim 10, wherein the weld is formed in the contact region along a portion of the top surface of the support member and the gear member is provided at the weld only.

13. The gear for a torque transmission device according to claim 5, wherein each of the one or more grooves is a ramp of a ball-ramp.

14. The gear for a torque transmission device according to claim 1, wherein the gear member is made of a sinter-hardening metal.

15. The gear for a torque transmission device according to claim 5, wherein the support member comprises a material having a minimum hardness of 57 HRC.

16. The gear for a torque transmission device according to claim 5, wherein the support member has a stress capacity of 3,000 MPa.

17. The gear for a torque transmission device according to claim 1, wherein the support member is made of wrought steel and the gear member is made of powdered metal.

18. A method of fabricating the gear for a torque transmission device of claim 1, comprising
providing the gear member and the support member, and
forming the weld between the support member and the gear member using a capacitor-discharge welding process.

19. The method of claim 18, wherein the capacitor-discharge welding process comprises
placing the gear member on the support member to form the contact region of the gear member and the support member;
placing an electrode on one surface of the gear member away from the contact region of the gear member;
placing another electrode on the support member away from the contact region of the support member; and
forming the weld at the contact region by capacitor discharge welding.

20. The method of claim 18, wherein
the support member is made of wrought steel and the gear member is made of powdered metal.

21. A gear for a torque transmission device comprising:
a powdered metal gear member having a first surface with teeth and a second surface opposite the first surface;
a wrought steel support member having a support surface that is a top surface with one or more grooves configured to accept an axial load and a side surface parallel to the support surface; and
a weld formed to contact a portion of the top surface of the wrought steel support without the one or more grooves and formed to contact the second surface of the powdered metal gear, wherein
the weld exists at a contact region between the wrought steel support member and the powdered metal layer and, at the contact region, each of the top surface of the wrought steel support member and the second surface of the powdered metal gear member at the contact region is ungrooved.
